(19) United States
(12) Patent Application Publication
(10) Pub. No.: US 2014/0273993 A1
(43) Pub. Date: Sep. 18, 2014

(54) RATING SUBJECTS

(71) Applicant: Call-It-Out, Inc., Santa Monica, CA (US)

(72) Inventor: Alexander David Grappo, Silverthorne, CO (US)

(73) Assignee: Call-It-Out, Inc., Santa Monica, CA (US)

(21) Appl. No.: 13/842,732

(22) Filed: Mar. 15, 2013

(51) Int. Cl. H04W 4/02

(52) U.S. Cl. CPC H04W 4/02
USPC 455/414.1

(57) ABSTRACT

Methods, systems, and apparatus, including computer programs encoded on computer storage media, for rating subjects. One of the methods includes receiving, at a user device, a rating of a real-world subject. A camera device associated with the user device is activated in response to receiving the rating of the real-world subject. Subject content of the rated real-world subject is received. The rating of the real-world subject is associated with the received subject content.

### BACKGROUND

This specification relates to user content systems.

User content systems can receive user content, e.g., images, videos, microblog messages, and status updates and can make such information available to other users over a network, e.g., the Internet.

Internet search systems aim to identify resources, e.g., web pages, images, text documents, multimedia content, e.g., videos, that are relevant to a user's information needs and to present information about the resources in a manner that is most useful to the user. Internet search engines generally return a set of search results, each identifying a respective resource, in response to a user submitted query.

Some search systems also provide an interactive mapping system. Users can submit a query to the interactive mapping system to search for map entities, e.g., cities, states, countries, addresses, business names, etc. In response to a query, the interactive mapping system can display a geographic region.

### SUMMARY

This specification describes how a system can allow users to rate real-world subjects, e.g., objects, people, places, or events, and capture corresponding subject content, e.g., images, video, or audio. The system can receive the user-specified subject rating and content and make such rating and content available for discovery by other users.

In general, one innovative aspect of the subject matter described in this specification can be embodied in methods that include the actions of receiving, at a user device, a rating of a real-world subject; activating a camera device associated with the user device in response to receiving the rating of the real-world subject; receiving, at the user device, subject content of the rated real-world subject; and associating the rating of the subject with the received subject content. Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. The subject content of the rated real-world subject comprises an image, video, or audio of the real-world subject. Activating a camera device associated with the user device in response to receiving the rating of the real-world subject is performed without requiring further input from a user. Receiving, at the user device, subject content of the rated real-world subject comprises receiving a URL of a resource about the real-world subject; and obtaining the resource using the URL of the resource. The real-world subject is an object, a place, or an event. The actions include providing the subject content and the associated rating to a serving system for access by other users.

Particular embodiments of the subject matter described in this specification can be implemented so as to realize one or more of the following advantages. Users can rate real-world subjects in an efficient and streamlined manner. A system can provide a platform for real-world subjects to be associated with multiple different ratings and multiple different items of subject content. Other users can more easily discover real-world subjects that people find to be awesome or awful, including real-world subjects for which online ratings are typically not available, e.g., a family pet. Other users can also search for subjects that people have rated highly and can search for highly-rated subjects that are near a particular location, in a particular category, or associated with a particular hashtag or keyword. The system can also make recommendations of items of subject content that are likely to be rated highly by a user based on subjects that the user has previously rated.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIGS. 1A-D illustrate example user interfaces of an example application for rating real-world objects and events.

FIG. 2 illustrates an example system.

FIG. 3 is a flow chart of an example process for rating a subject.

FIG. 4 illustrates an example user interface of an application for finding rated subject content,

FIG. 5 is a flow chart of an example process for searching for subject content.

Like reference numbers and designations in the various drawings indicate like elements,

### DETAILED DESCRIPTION

FIG. 1A illustrates an example user interface 110 of an application for rating real-world objects and events. The application can be installed on a mobile user device 102, e.g., a smartphone. A user can use a user interface 110 of the application to assign ratings to objects or events, capture images and videos of the objects or events, upload captured images and videos of objects and events to a serving system, and share the captured images and videos with others.

This specification will generally refer to assigning ratings to “subjects,” which can be real-world entities of some kind, e.g., real-world objects, events or sequences of events, people, places of business, works of art, or products, to name just a few examples. This specification will generally also refer to capturing “subject content,” which includes uploading or specifying the locations of images, video, or audio of the real-world subjects, or representing the real-world subjects.

The user interface 110 includes a ratings interface control 112 for selecting a rating and a button interface control 114 for confirming the rating of a subject. In FIGS. 1A-C, the ratings interface control 112 is illustrated as a slider interface control, although the application can include any other appropriate user interface control for selecting a rating. For example, the application can enumerate possible ratings in the user interface for selection by a user by providing a list, drop-down menu, or radio buttons, for example. Ratings may also be provided by voice control using speech recognition technologies. Similarly, the button interface control 114 need not be a selectable button and can include any other appropriate rating confirmation mechanism, e.g., a voice command or after inaction by the user. In some implementations, upon a user selecting a rating, the rating is automatically confirmed without further interaction by the user after some period of time has passed, e.g., 1 second.

FIG. 1B illustrates the user interface 110 with the ratings interface control 112 moved to a position at the far left. In this example, the position at the far left represents a rating of “Awful” FIG. 1C illustrates the user interface 110 with the ratings interface control 112 moved to a position at the far right. In this example, the position at the far right represents a rating of “Awesome.”

Upon selecting a rating using ratings user interface control 112 and confirming the rating user the button interface control 114, the application can activate an integrated camera device of the user device 102 for capturing an image or video of a rated subject. Using the interface 110 allows a user to quickly rate and capture rated subjects in a streamlined and efficient manner.

In particular, the user interface 110 allows a user to rate real-world subjects rather than simply rating an image or video of the subject. In other words, the image quality, framing, or perspective of the captured image or video of the subject is intended to be secondary to the rating of the real-world subject. Thus, when a user rates subjects first and then captures the subject second, other users who are viewing rated and captured subjects will understand that the assigned rating corresponds to the real-world subject, and not necessarily to the image or video of the subject.

The ratings that are possible to assign through the application can also vary in their values and in number in a variety of ways. For example, instead of manipulating a slider, the application can require a user to select a number of stars out of five possible stars, a numerical value between one and ten, other custom enumerated rating values, e.g., in a range from “Terrible” to “Outstanding,” or any other appropriating rating selection. In some implementations, the ratings represent a comparative scale from unfavorable to favorable or positive to negative. However, the possible ratings presented by the application need not share a mathematical, comparative, semantic, or other type of relationship.

FIG. 1D illustrates an example user interface 111 of the application for capturing subject content. After a user confirms a rating, the application can present user interface 111 for capturing content of the rated subject.

A user can use viewfinder 120 to locate the rated subject and preview a captured image or video of the rated subject. When a user selects camera interface control 124, the application directs an integrated camera of user device 102 to capture an image, audio, or video of the rated subject. The user can alternatively decline to capture the subject content by selecting “cancel” interface control 126.

The user interface 111 can also allow a user to choose a preexisting subject content using image selection interface control 122. For example, the user can select preexisting image or video stored locally on the user device 102. In addition, the application can also allow the user to browse subject content stored remotely that is accessible by the user device, e.g., images on the Internet. In some implementations, the application allows the user to provide a resource location, e.g. a URL, of the subject content, which can be e.g. a resource location of an image, a video, or a website.

After selecting or capturing an image or a video, the application can provide the user with options to apply various filters to the image or video data or other manipulation options. For example a user can choose to have an image of the subject, originally captured in color, to appears as a black-and-white image.

The application can associate the assigned rating with the captured subject content. The user can use the application to associate other metadata in addition to a rating with the subject content, for example, a description or title of the subject content or a location of the real-world subject. In addition, the application may also include other dedicated user interfaces for associating metadata with the rated subject content. For example, the application may include a user interface through which the user can assign a category or topic with the subject content. Topic or category information may be associated with the subject content as a “hashtag” or keyword that signals a topic or category occurring inline within text, e.g., within a title or a description of the subject content. In some implementations, the application may automatically associate geographic location information, e.g., GPS coordinates, with the subject content that corresponds to where the user device 102 was located when the subject content was captured.

The application can store the subject content locally on user device 102, or the application can communicate with a serving system to upload the subject content for access by other users of the serving system. The serving system may also, but need not, maintain and distribute the application for installation on mobile user devices.

At any point in the process of rating and capturing subject content as illustrated in FIGS. 1A-1D, the user may select menu options 131-134. Upon selection of the “profile” menu option 131, the application presents account information of the user with the serving system and may allow the user to edit particular information of the user's account. For example, the user may edit his or her name, home city or address, a profile picture, or other information associated with the user's account.

Upon user selection of the “Search” menu option 132, the application presents a user interface for searching for information about rated subjects according to a variety of criteria, e.g., by geographic location. The user can also select the “Feed” menu option 134, and in response the application will communicate with the serving system to obtain a feed of information about rated subjects that have been captured by other users. The search and feed functionalities of the user application will be described in more detail below with reference to FIGS. 4-5.

Upon user selection of the “Rate It!” menu option 133, the application presents user interface 110 for rating subjects. Upon user selection of the “My Ratings” menu option 135, the application can present subject content that the user has captured, information that the application may obtain by communicating with the serving system,

FIG. 2 illustrates an example system 200. The example system includes a user device 210, a network 220, and a serving system 230. The user device 210 can communicate over network 220 to provide subject content 202 and associated metadata to the serving system 230. The user device 210 can also provide a query 204 to request subject content from the serving system 230 and can receive subject content search results 206 from the serving system 230 in response to the query 204. Selection of a subject content search result 206 can also cause the user device 210 request the full subject content 208 from the serving system 230.

A user device 110 may be a smart wristwatch, a mobile phone, a portable music player, a tablet computer, a laptop computer, a PDA (Personal Digital Assistant), a smartphone, or another handheld or wearable mobile device. The user device 210 can include one or more processors 211, a display 212, one or more speakers 213, one or more input devices 215, a network interface 214, a camera 216, a navigation module 217, and a non-volatile computer-readable medium 218. In other implementations, the user device 210 is not portable or mobile, but rather is a desktop or laptop computer or a server. In still other implementations, some of these structural elements are omitted or combined.

The display 212 may display video, graphics, images, and text that make up the user interface for the software applications used by the user device 210, and for the operating system programs used to operate the user device 210. Among the possible elements that may be displayed on the display 212 are various indicators, e.g., new mail, active phone call, data transmit/send, signal strength, battery life, and application icons, e.g., web browser, phone application, search application, contacts application, mapping application, email application. In one example implementation, the display 212 is a quarter video graphics array (QVGA) thin film transistor (TFT) liquid crystal display (LCD), capable of 16-bit or better color.

The one or more speakers 213 allow the user device 210 to convert an electrical signal into sound, such as a voice signal from another user generated by a telephone application program, or a ring tone signal generated from a ring tone application program.

The camera 216 allows the user device 210 to capture digital images, and may be a scanner, a digital still camera, a digital video camera, or other digital input device. In one example implementation, the camera 216a is a 12 megapixel (MP) or more camera.

The navigation module 217 includes a compass 271a, an accelerometer 217b, and a GPS (Global Positioning Satellite) receiver 217c. The GPS receiver 217c receives GPS signals in order to determine a current location. The compass 217a determines a direction pointed to by the orientation of user device 210. The accelerometer 217b may, for example, measure tilt, motion, or acceleration of the user device 210. The navigation module 217 may include other functionality, such as the ability to determine the location of the mobile device 210 using triangulation techniques based on WiFi signals and/or cellular tower signals.

The processor 211 processes operating system or application program computer instructions for the user device 210. The input devices 215 may include, for example, a wireless keyboard. A keyboard may be used for entering text data and user commands into the user device 210.

The network 220 can include, for example, one or more of the Internet, a wireless local area network (WLAN) or WiFi network, a Third Generation (3G), Fourth Generation (4G), or other mobile telecommunications network, a wired Ethernet network, a private network such as an intranet, Wide Area Networks (WANs), Local Area Networks (LANs), analog or digital wired and wireless telephone networks, e.g., a PSTN, Integrated Services Digital Network (ISDN), and Digital Subscriber Line (xDSL), radio, television, cable, satellite, and/or any other delivery or tunneling mechanism for carrying data services, or any appropriate combination thereof. Networks may include multiple networks or subnetworks, each of which may include, for example, a wired or wireless data pathway.

The serving system 230 may be connected to the network 220 and possibly to one or more other networks over the network interface 232. Similarly, the user device 210 may be connected to the network 220 and possibly to one or more other networks over the network interface 214 of the user device 210.

The processor 231 processes operating system or application program computer instructions for the serving system 230, and may be part of one or more computers in one or more locations that are coupled to each other through a network, e.g., network 220.

The computer-readable medium 233 stores and records information or data, and may be an optical storage medium, magnetic storage medium, flash memory, or any other storage medium type. The medium 233 includes a search engine 234, a subject content database 235, a maps database 236, and a user database 238. The search engine 234 obtains subject content search results 206 that the search engine 234 identifies as being responsive to a query. The search engine 234 can, for example, identify subject content search results 206 that identify subject content for a query using an index database that stores indexed resources, e.g., images, videos, or other types of subject content.

The subject content database 235 stores subject content and associated metadata, e.g., location information, ratings, descriptions, titles, and associated users. The search engine 234 can search subject content database 235 to identify subject content that is responsive to a received query.

The user database 238 stores information about users of the serving system. For example, the user database 238 can store usernames, full names, home cities, identifiers of subject content uploaded by the user, in addition to a variety of other types of information about users of the serving system 230.

The query prefix 240 also includes location information, e.g., generated by navigation module 216 of user device 210. The location information identifies a location where the query prefix was issued. The location information can include latitude/longitude or other coordinates, a city and state, a ZIP code, or some combination thereof.

While FIG. 2 illustrates an example system for serving subject content as described by this specification, other systems are possible. For instance, one or more of the functionalities described in association with the serving system 230, above, may actually be performed by the user device 210, and vice versa. Furthermore, one or more modules, databases, and applications shown as being stored in medium 233 may actually be stored in the medium 218, and vice versa. Similarly, a user interface may be generated and displayed at the user device 210 using information received from the serving system 230. Alternatively, the user interface may be generated at the serving system 230, where the serving system 230 transmits code, e.g., an HTML document, that, when rendered by the user device 210, causes the user device 210 to display the user interface.

FIG. 3 is a flow chart of an example process for rating a subject. In general, a user device captures a rating of a subject and then captures subject content of the subject. The process can be implemented by one or more computer programs installed on one or more computers. The process will be described as being performed by a system of one or more computers, e.g., the user device 302 of FIG. 1A.

The system receives, at a user device, a rating of a real-world subject (310). As described above with reference to FIGS. 1A-D, a user can input a rating using an interface of an application installed on the user device.

The system activates a camera associated with the user device (320). Upon receiving the rating, the system can activate a camera that is integrated with the user device. In some implementations, the camera is activated directly after receiving the rating of the subject and without requiring further input from the user.

The system receives subject content of the subject (330). The system can receive the subject content either from the output of the camera or from a user selection of a preexisting image, video, or other content that is stored on or accessible from the user device.

The system associates the rating of the subject with the subject content (340). For example, the system can maintain a subject content database that is local to the user device and can assign the rating of the subject with the subject content.

The system can also receive and associate other metadata with the subject content. For example, in some implementations, the system automatically obtains a geographic location of the user device at the time the subject content was captured and automatically associates the geographic location with the subject content. A user can manually associate other metadata with the subject content, for example, a category, title, description, date, in addition to other types of metadata.

After associating the subject rating with the subject content, the system can provide the subject content and associated metadata to a serving system. This can allow other users to search for and access the subject content and associated subject rating.

FIG. 4 illustrates an example user interface 113 of an application for finding rated subject content. The application can be installed on the mobile user device 102, and a user can use the user interface 113 of the application to search for subject content. The application can present user interface 113 for example in response to a user selection of the search menu option 132.

The user interface 113 includes a viewport 150 that the system can use to display map data of a particular geographic location. The map data can be obtained by communicating with a serving system, e.g., serving system 230, as described above with reference to FIG. 2, or the user device 102 can communicate with other entities to obtain such data. A user can generally pan or zoom the viewport, that is, change the geographic area depicted in the viewport 150, e.g., by using a scrolling or other gesture input. In some implementations, the scrolling input is accomplished by swiping a finger across the surface of a touch-sensitive display of the user device 102.

Displayed in the illustrated viewport 150 are three subject content indicators 162a-b and 164. A subject content indicator marks a geographic location of a subject for which a user has rated and uploaded corresponding subject content. For example, subject content indicator 164 marks the geographic location of a rated subject. Subject content indicators 162a and 162b mark the geographic location of the same rated subject for which two different elements of subject content are available. For example, two different users could rate and upload subject content of the same outdoor sculpture. Each element of rated subject content will be presented in the viewport 150, even though both refer to the same sculpture. The system can also select a subset of available subject content indicators for the geographic area in the viewport. 150, e.g. by a measure of popularity or some other ranking.

User selection of a subject content indicator will cause the application to display more detail about the subject content. In some implementations, the application requests and downloads the subject content from a serving system for presentation through user interface 113. In some implementations, the user can comment on or vote on subject content. For example, the user can “vote up” subject content that the user finds interesting, useful, or otherwise noteworthy. The application can then communicate with the serving system to upload comments or votes provided by the user for access by other users.

A user can search for subject content associated with a location within viewport 150 by using search box 142. The search box 142 can be used to search for a geographic location, e.g., by entering an address, a city, or a ZIP code. The search box 142 can also be used to search for subject content by other metadata besides location, for example, by rating, a category, a hashtag, a description, or by a username of a user who uploaded the search content.

A user can also explicitly specify a desired search radius by interacting with radius interface control 144. Upon specification of a search radius, the application can limit the viewport 150 to the specified search radius. In some implementations, the application limits the viewport 150 to the specified search radius centered on the current location of the user device 102. The radius interface control 144 may also include presentation elements indicating a minimum radius 144a, a maximum radius 144b, and a currently selected radius 144c. As mentioned above with reference to FIG. 1A, any appropriate radius selecting interface control can also be used, e.g., a rotary scale input, a text input field, or a drop-down radius selector, to name just a few examples.

The search box 142 and the radius interface control 144 can be also used in tandem to specify the geographic area shown in the viewport 150. The user can enter both a geographic location into the search box 142 and specify a radius using the radius interface control 144. In response, the application can center the viewport 150 on the specified geographic location and limit the viewport to the search specified by the user. The application can adapt the provided search radius based on a type of geographic entity specified. For example, the application can use a larger search radius if the user searches for a city name than if the user searches for an address. Similarly, the application can use a larger search radius if the user searches for a country than if the user searches for a state.

Each subject content indicator presented in the viewport 150 may also indicate the rating associated with the subject, allowing users of user interface 113 to see how people generally have rated a particular real-world subject. For example, subject content indicators that appear to be clustered in viewport 150 around the geographic location of the outdoor sculpture can give a user of user interface 113 an immediate sense for how the outdoor sculpture is perceived or rated by users generally.

Two elements of subject content for the same subject will typically be different, e.g., two different images of the same sculpture. Thus, unlike other rating mechanisms, the presentation of subject content indicators on viewport 150 will typically not show an average or otherwise composite rating for any one particular subject that has been rated multiple times. Rather, the viewport 150 can show each of multiple subject content indicators for a single subject.

Moreover, because the application can be used to rate any real-world subject and many real-world subjects are located in close proximity, the system may also lack an explicit association of subject content to a subject by geographic location. In other words, two images taken at the same geographic location may refer to completely different subjects, e.g., an image of the sculpture and a video of a person dancing near the sculpture, taken at the same location.

However, the system can allow users to make an explicit association between a real-world subject and one or more elements of subject content through the use of keyword or hash tag metadata. For example, a user can rate his pet dog named George as “Awesome!”, capture an image of the dog, and upload the corresponding rated subject content image to a serving system. The user can include the hashtag “#georgethedog” in the description of the subject content to signal an explicit association of the real-world subject with the rating and subject content image. Meanwhile, the user's neighbor may use user interface 113 on his own user device to search for subject content near him. Upon seeing George the dog rated so highly, the neighbor can instead rate George the dog as “Awful!”, capture his own a picture of the dog, and include the same hashtag “#georgethedog” when uploading the subject content. The hashtag will then signal an explicit association of the rating with the real-world subject, signaling to others that opinions about George are mixed at best. In this way, the application allows users to rate any real-world subject, even those for which online ratings are typically unavailable, e.g., family pets.

The user interface 113 can also include a ratings interface control for filtering subject content indicators by rating, e.g. a slider user interface control. In some implementations, the ratings interface control is similar to the ratings interface control 112 as shown in FIGS. 1A-C. For example, the user can specify that he or she would only like to receive subject content search results for subject content having a particular rating, e.g. only an “Awesome!” rating, only a rating above four stars, or only a rating above 6 out of 10. In some implementations, selection of a rating through the ratings interface control causes the application to obtain subject content search results for subject content having a the specified rating or a more favorable rating than the specified rating.

For example, a user can set the ratings interface control to “Awesome!” to direct the application to show, in the viewport 150, only subject content indicators that are associated with subject content rated as “Awesome!” or better. When the ratings interface control is used in combination with the search box 142, the user can for example search for subject content by hashtag or description that has a rating as specified by the user's criteria.

The user can also use a ratings interface control along with the radius interface control 144 to search for subject content having a particular rating that is also associated with a geographic location within the specified radius. Similarly, the user can use the search box 142, the radius interface control 144, and a ratings interface control all together to search for subject content. For example, the user can search for only subject content that is rated as “Awful!” having the hashtag “#hotel” and that is associated with geographic locations within 2 miles of the user's current location.

The application can also allow the user to specify a variety of default search criteria that can be applied during searches for subject content. For example, the user can specify a default ratings criterion, e.g. only “Awesome!”, a default radius criterion, e.g. within 500 feet. The user can also specify one or more default categories or hashtags to indicate that he or she would only like to receive subject content search results for subject content associated one of the specified categories or hashtags, e.g. only the “Dining” and “Entertainment” categories, or only the “#hotels” or “#pizza” hashtags. In some implementations, the default search criteria can be specified by selecting the “Profile” menu option 131.

The user can also search for and discover subject content by accessing the “Feed,” e.g. by selecting “Feed” menu option 134. The application will then search for and obtain subject content for the user. The user can control the subject content that the application populates in the Feed in a variety of ways. For example, the user can specify one or more usernames of other people whose subject content that the user would like see appear in the Feed. The application can also obtain and populate the Feed with subject content that is “trending,” which can include subject content that many users are viewing, commenting on, or voting on. Trending subject content can also include subject content associated with hashtags or keywords that many users are viewing or searching for. In some implementations, the user can also select “trending subject content” as one of the default search criteria.

The application can also populate the Feed using one or more feed criteria specified by the user. In other words, upon selecting the “Feed” menu option 134, the application can search for and obtain subject content from the serving system that meets the one or more feed criteria. For example, the user can specify a hashtag “#cool” as a feed criterion, which will cause the application to populate the user's Feed with subject content associated with the “#cool” hashtag. In some implementations, the application uses the user's default search criteria as the feed criteria as well.

In addition, the serving system can make recommendations for the user by providing, to the user device, subject content that the user may be interested in for population in the user's Feed. The serving system may identify subject content that is related to or otherwise associated with the hashtags, categories, usernames, or other items in the user's default search or feed criteria. For example, the serving system may recognize that people who favorably rate subject content having the hashtag “#beach” often favorably rate subject content having the hashtag “#pizza.” Therefore, if the user has “#beach” as part of the default search or feed criteria the serving system may additionally provide subject content having the hashtag “#pizza” for population in the user's Feed.

FIG. 5 is a flow chart of an example process for searching for subject content. In general, a user device provides a subject content query to a serving system and receives subject content search results. The process can be implemented by one or more computer programs installed on one or more computers. The process will be described as being performed by a system of one or more computers, e.g., the serving system 230 of FIG. 2.

The system receives, from a user device, a subject content query (510). The subject content query generally requests subject content search results. The subject content query can also include other metadata, e.g., category, topic keywords, usernames, or hashtags.

The system receives a location (520). For example, the system can receive a location of the user device. Location information can be determined by the user device itself, e.g., by using a navigation module 217 as described in reference to FIG. 2. The location of the user device can also be determined at a serving system by using other methods, for example, by geolocating an IP address associated with the user device.

The location may also be determined from the viewport of a user application that displays a particular geographic area. The system can select a particular geographic location that is within the particular geographic area, e.g., a geographic location corresponding to the center of the viewport.

The system may also determine a location from the subject content query itself. For example, a user can submit a subject content query that specifies the name of a geographic entity, e.g. “San Francisco.” The system can then access a geographic database and derive a location corresponding to the geographic entity San Francisco.

The system receives a user selection of a radius (530). For example, a user can select a radius by interacting with a radius selection interface control, e.g., by using a rotary interface control or a slider interface control, e.g. radius interface control 144. In some implementations, a user can enter an explicit radius, e.g. one mile, into the application to select a radius.

The system obtains one or more subject content search results that satisfy the query (540). To satisfy the subject content query, subject content will generally need to be associated with a geographic location that is within a threshold distance of the geographic location of the user device. The threshold distance can be equal to or based on the value of the received radius selection.

The system can identify subject content that satisfies the subject content query by being within the threshold distance and matching any other parameters specified by the subject content query, e.g., hashtags, ratings, or metadata. In some implementations, the system automatically uses one or more default search criteria specified by the user when searching for subject content that satisfies the subject content query. The system can then generate subject content search results corresponding to the identified subject content.

The system provides one or more subject content search results (550). In response to the subject content query, the system can provide subject content search results to a user application installed on the user device. The user device can display the subject content search results on a map interface of the user device to give the user a sense of where the specified subjects are in relation to the specified location.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them. The computer storage medium is not, however, a propagated signal.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer implemented method comprising:
receiving, at a user device, a rating of a real-world subject;
activating a camera device associated with the user device in response to receiving the rating of the real-world subject;
receiving, at the user device, subject content of the rated real-world subject; and
associating the rating of the real-world subject with the received subject content.

2. The method of claim 1, wherein the subject content of the rated real-world subject comprises an image, video, or audio of the real-world subject.

3. The method of claim 1, wherein activating a camera device associated with the user device in response to receiving the rating of the real-world subject is performed without requiring further input from a user.

4. The method of claim 1, wherein receiving, at the user device, subject content of the rated real-world subject comprises:
receiving a URL of a resource about the real-world subject; and
obtaining the resource using the URL of the resource.

5. The method of claim 1, wherein the real-world subject is an object, a place, or an event.

6. The method of claim 1, further comprising providing the subject content and the associated rating to a serving system for access by other users.

7. A system comprising:
a user device comprising one or more computers and one or more storage devices storing instructions that are operable, when executed by the one or more computers, to cause the one or more computers to perform operations comprising:
receiving, at a user device, a rating of a real-world subject;
activating a camera device associated with the user device in response to receiving the rating of the real-world subject;
receiving, at the user device, subject content of the rated real-world subject; and
associating the rating of the real-world subject with the received subject content.

8. The system of claim 7, wherein the subject content of the rated real-world subject comprises an image, video, or audio of the real-world subject.

9. The system of claim 7, wherein activating a camera device associated with the user device in response to receiving the rating of the real-world subject is performed without requiring further input from a user.

10. The system of claim 7, wherein receiving, at the user device, subject content of the rated real-world subject comprises:
receiving a URL of a resource about the real-world subject; and
obtaining the resource using the URL of the resource.

11. The system of claim 7, wherein the real-world subject is an object, a place, or an event.

12. The system of claim 7, wherein the operations further comprise providing the subject content and the associated rating to a serving system for access by other users.

13. A computer program product, encoded on one or more non-transitory computer storage media, comprising instructions that when executed by one or more computers cause the one or more computers to perform operations comprising:
receiving, at a user device, a rating of a real-world subject;
activating a camera device associated with the user device in response to receiving the rating of the real-world subject;
receiving, at the user device, subject content of the rated real-world subject; and
associating the rating of the real-world subject with the received subject content.

14. The computer program product of claim 13, wherein the subject content of the rated real-world subject comprises an image, video, or audio of the real-world subject.

15. The computer program product of claim 13, wherein activating a camera device associated with the user device in response to receiving the rating of the real-world subject is performed without requiring further input from a user.

16. The computer program product of claim 13, wherein receiving, at the user device, subject content of the rated real-world subject comprises:
receiving a URL of a resource about the real-world subject; and
obtaining the resource using the URL of the resource.

17. The computer program product of claim 13, wherein the real-world subject is an object, a place, or an event.

18. The computer program product of claim 13, wherein the operations further comprise providing the subject content and the associated rating to a serving system for access by other users.
